(19) United States
(12) Patent Application Publication
(10) Pub. No.: US 2013/0328686 A1
(43) Pub. Date: Dec. 12, 2013

(54) SYSTEM AND METHODS FOR MONITORING HEATING ELEMENTS

(71) Applicant: TYLER NEMES, DELRAY BEACH, FL (US)

(72) Inventor: TYLER NEMES, DELRAY BEACH, FL (US)

(73) Assignee: TWIN-STAR INTERNATIONAL, INC., DELRAY BEACH, FL (US)

(21) Appl. No.: 13/490,803

(22) Filed: Jun. 7, 2012

(51) Int. Cl. G08B 21/18

(52) U.S. Cl. CPC G08B 21/185
USPC 340/640

(57) ABSTRACT

Systems and methods for monitoring infrared heating elements are described. The system can include a plurality of electric infrared heating elements connected to a power source and installed in a heating device and an electronic monitoring system connected to the power source and communicatively connected to each infrared heating element. The electronic monitoring system can feature a computer and an alert system for creating an alert to notify a user when one of the infrared heating elements has ceased functioning. Each infrared heating element can be labeled so that each alert generated by the alert system can be matched with the label that corresponds to the non-functioning infrared heating element about which the alert has been generated.

### FIELD OF THE INVENTION

The invention relates to electric heating devices. More particularly, the invention relates to systems and methods for monitoring infrared heating elements installed in an electric heating device to detect when one of the infrared heating elements has ceased functioning and to create an alert to a user that identifies the non-functioning infrared heating element so that it can be replaced.

### BACKGROUND

Conventional electric heating devices, including both electric heaters and electric fireplaces, incorporate heating elements that produce heat, which is blown or which radiates out of the electric heating device to increase the temperature of a space such as a room. Although various types of heating elements have been used, commonly, electric heating devices utilize infrared bulbs as heating elements. Although the electric heating device may feature only a single infrared bulb, generally, electric heating devices include a plurality of infrared bulbs to generate heat. Through usage or as a result of defects, infrared bulbs eventually cease to function. In conventional electric heating devices in which infrared bulbs are installed, the electric heating device provides no system or method for determining which infrared bulb of the plurality of infrared bulbs installed in the heating device has ceased to function. Moreover, in addition to failing to provide a means for determining which infrared bulb is not functioning, many conventional electric heating devices do not allow a user to access and replace a non-functioning infrared bulb. As a result, as one or more infrared bulbs cease to function, because the bulbs cannot be replaced, the electric heating device's performance declines or fails to work entirely. The user is left with options to pay the manufacturer or another service provider to repair the heating device or to discontinue using, and potentially discard, the non-functioning electric heating device.

Conventional electric heating devices not only fail to provide any means for determining which infrared bulb has stopped functioning, they also provide no means to alert the user when one or more of the plurality of infrared bulbs installed inside the device has ceased functioning. In the absence of an alert system that notifies the user when one or more of the infrared bulbs has ceased to function, the user may not be aware that the electric heating device is not heating properly or efficiently. Even if the user becomes aware that the electric heating device is not heating properly or efficiently, with conventional electric heating devices, the user is generally unable to access and replace non-functioning infrared bulbs due to the manufacturing designs of these devices. If the infrared bulbs were accessible to the user in a conventional electric heating device, the heating device still lacks any system, device, or apparatus that would permit the user to determine which of the infrared bulbs is not functioning. Such determinations cannot be made based on visual inspection of an infrared bulb either when installed in the device or when removed.

A need exists for electric heating devices that feature systems and methods for monitoring the functionality of heating elements installed in the devices. A further need exists for electric heating devices designed to permit a user to access and replace non-functioning heating elements. Still another need exists for systems that alert the user when one or more of a plurality of heating elements have ceased to function. Yet a further need exists for systems that allow the user to determine which of the plurality of heating elements installed in the electric heating device has ceased to function.

### SUMMARY

The invention relates to systems and methods for monitoring infrared heating elements are described. The system can include a plurality of electric infrared heating elements connected to a power source and installed in a heater and an electronic monitoring system connected to the power source and communicatively connected to each infrared heating element. The electronic monitoring system can feature a computer and an alert system for creating an alert to notify a user when one of the infrared heating elements has ceased functioning. Each infrared heating element can be labeled so that each alert generated by the alert system can be matched with the label that corresponds to the non-functioning infrared heating element about which the alert has been generated.

The systems and methods described herein provide an advantage over conventional electric heating devices in that the user is given access to remove and replace non-functioning heating elements. Another advantage of the present systems and methods over conventional electric heating devices relates to their ability to monitor a plurality of heating elements for continuing functionality, to alert the user when one or more of the plurality of heating elements has ceased to function, and to permit the user to determine which of the plurality of heating elements has ceased to function so that non-functioning heating elements can be replaced. As a result, the electric heating device, with its incorporated system for monitoring heating elements, provides superior and long-lasting functionality and efficiency in generating heat to warm a space such as a room.

Accordingly, the invention features a system for monitoring heating elements, which can include an electric heating element connected to a power source and installed in a heating device and an electronic monitoring system connected to the power source and communicatively connected to the electric heating element. The electronic monitoring system can include a computer and an alert system for creating an alert to notify a user that the electric heating element has ceased functioning.

In another aspect, the invention can feature the electric heating element including a plurality of heating elements.

In another aspect, the invention can feature the plurality of heating elements being infrared heating elements.

In another aspect, the invention can feature the plurality of heating elements including a combination of infrared heating elements and at least one heating element that is not an infrared heating element.

In another aspect, the invention can feature the electric heating element being removably installed in a socket.

In another aspect, the invention can feature the electronic monitoring system being capable of separately monitoring each of the plurality of infrared heating elements to determine that each heating element is functioning to produce heat.

In another aspect, the invention can feature the electronic monitoring system being capable of detecting when one or more of the plurality of infrared heating elements has ceased functioning.

In another aspect, the invention can feature the computer of the electronic monitoring system being programmed to create an alert signal when one or more of the plurality of infrared heating elements is detected to have ceased functioning.

In another aspect, the invention can feature the computer transmitting the alert signal to the alert system so that the alert system creates the alert that is detectable by the user to alert the user that one or more of the plurality of infrared heating elements is not functioning to produce heat.

In another aspect, the invention can feature the system further including a display screen and the alert including a visual alert that is displayed on the display screen.

In another aspect, the invention can feature the system further including an audio device capable of producing a sound and the alert including a sound that is produced by the audio device.

In another aspect, the invention can feature the system being capable of producing a plurality of alerts each of which is unique to one of the plurality of infrared heating elements that ceases to function.

In another aspect, the invention can feature the heating device being an electric heater.

In another aspect, the invention can feature the system being installed within a housing of the electric heater and being accessible via a removable panel.

In another aspect, the invention can feature the heating device being an electric fireplace.

In another aspect, the invention can feature the system being installed within a housing of the electric fireplace and being accessible via a removable panel.

In another aspect, the invention can feature each of the plurality of infrared heating elements including a label that corresponds visually with the alert created by the electronic monitoring system.

In another aspect, the invention can feature the electronic monitoring system being communicatively connected to the plurality of infrared heating elements by a plurality of wiring components, wherein each single wiring component of the plurality of wiring components is communicatively connected to only one of the plurality of infrared heating elements, wherein the label includes a first label, and wherein each wiring component of the plurality of wiring components is identifiable by a second label that is identical to its corresponding first label so that when one of the plurality of infrared heating elements ceases to function, the non-functioning infrared heating element is identifiable by the user based upon the first and second labels associated with the non-functioning infrared heating element and its corresponding unique alert created by the alert system.

In another aspect, the invention can feature any heating element of the plurality of infrared heating elements, which is indicated by the electronic monitoring system to have ceased functioning, is removable from a socket in which it is installed and is replaceable with a replacement infrared heating element.

A method of the invention can be used to monitor the functionality of a heating element installed in a heating device such as, for example, an electric fireplace or an electric heater. The method can feature the steps of: (a) connecting a plurality of electric heating elements installed in the heating device to a power source; (b) connecting an electronic monitoring system installed in the heating device to the power source and communicatively connecting the plurality of electric heating elements to the electronic monitoring system, wherein the electronic monitoring system includes a computer and an alert system; and (c) using the alert system, creating an alert to notify a user that at least one of the plurality of electric heating elements has ceased functioning.

Another method of the invention can feature the alert being unique to the at least one of the plurality of electric heating elements that has ceased to function.

Another method of the invention can feature the method further including the step of: (d) labeling each of the plurality of electric heating elements with a unique label so that when at least one of the plurality of electric heating elements ceases to function, the at least one non-functioning electric heating element is identifiable by the user based upon the unique label and its corresponding unique alert.

Another method of the invention can feature the electronic monitoring system being communicatively connected to the plurality of infrared heating elements by a plurality of wiring components, wherein each single wiring component of the plurality of wiring components is communicatively connected to only one of the plurality of infrared heating elements, wherein the unique label comprises a first label, and wherein the method further includes the step of: (e) labeling each wiring component of the plurality of wiring components with a second label that is identical to its corresponding first label, and when one of the plurality of infrared heating elements ceases to function, identifying the non-functioning infrared heating element based upon the first and second labels associated with the non-functioning infrared heating element and its corresponding unique alert created by the alert system.

Another method of the invention can feature the method further including the step of: (f) replacing at least one of the plurality of electric heating elements that has ceased to function based upon the user's identification of that heating element as non-functioning as a result of the user's detection of the alert.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of a system for monitoring heating elements installed in an electric heater, shown with a side panel and an interior panel removed.

FIG. 2 is a right side view of the system of FIG. 1.

FIG. 3 is a close-up view of the system of FIG. 1.

FIG. 4 is a close-up view of the system of FIG. 1 with one of the heating elements partially removed for replacement.

FIG. 5 is a right side view of the system of FIG. 1 with the interior panel installed to cover the heating elements.

FIG. 6 is a right side view of the system of FIG. 1 with the side panel installed to conceal an interior space of a housing of the system.

FIG. 7 is close-up right side view of another embodiment of a system for monitoring heating elements.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention is not limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

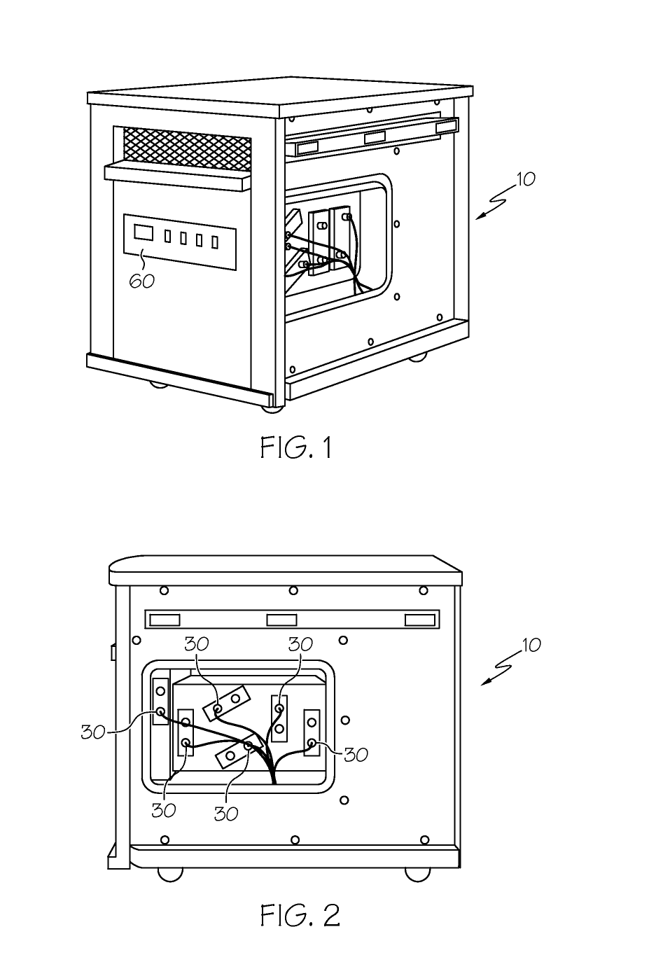

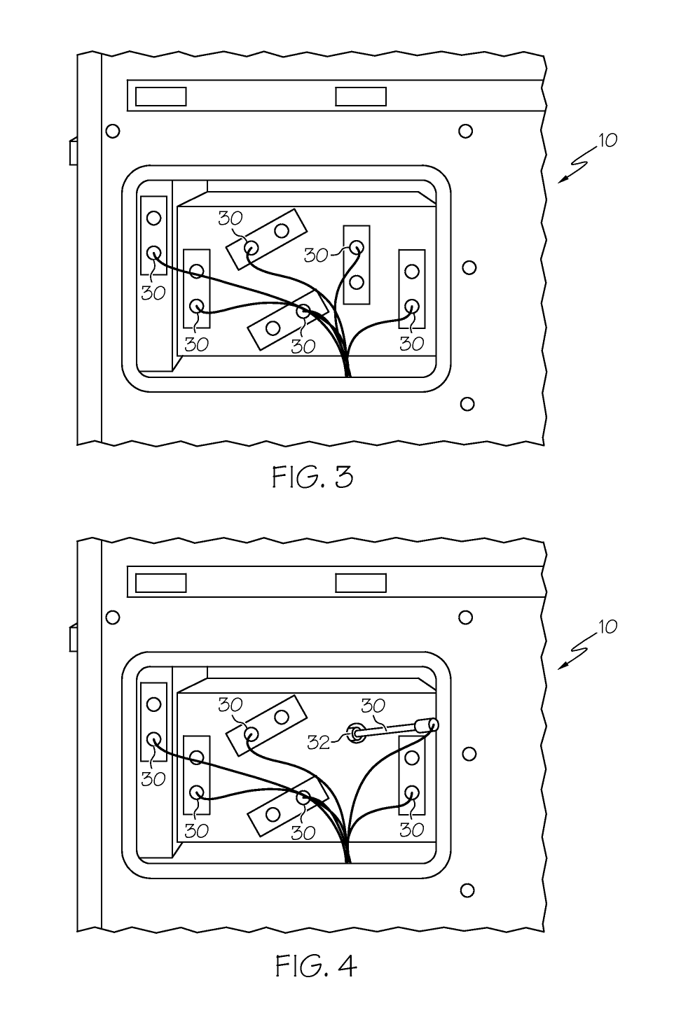

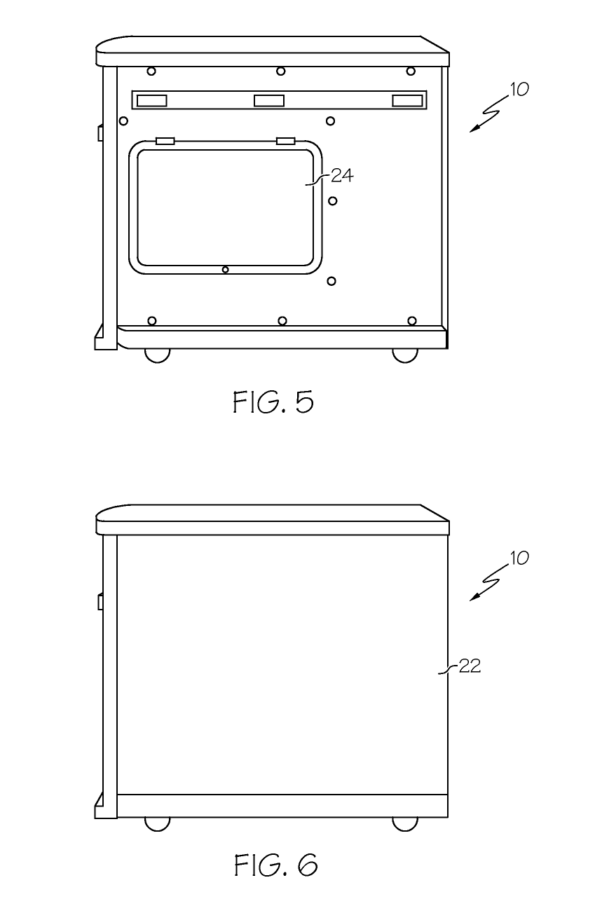

The present invention will now be described in detail with reference to embodiments thereof as illustrated in the accompanying drawings, which are provided by FIG. 1-7.

The invention provides a system 10 for monitoring the functionality of heating elements 30 installed in an electric heating device. The electric heating device can be an electric heater, an electric fireplace, or an electric fireplace insert. The electric heating device can feature a housing in which other components of the system 10 may be installed. The system 10 can include an electric heating element 30 connected to a power source and installed in a heater and an electronic monitoring system 10 connected to the power source and communicatively connected to the electric heating element 30. The electronic monitoring system 10 can feature a computer and an alert system for creating an alert to notify a user that the electric heating element 30 has ceased functioning.

The electric heating element 30 can be a single heating element, however, in an exemplary embodiment, the electric heating element 30 includes a plurality of heating elements. In a more exemplary embodiment, the plurality of heating elements 30 are infrared heating elements 30, e.g., infrared bulbs. In other embodiment of the system 10, the plurality of heating elements 30 can feature a combination of infrared heating elements and at least one heating element 30 that is not an infrared heating element. For example, the heating element 30 that is not an infrared heating element can be a nichrome heating element such as a nichrome wire, ribbon, or strip. Any other suitable heating element 30 may also be incorporated into the system 10 for use alone or in combination with other types of heating elements 30, e.g., with infrared heating elements. Each electric heating element 30 can be removably installed in a socket 32 that holds the heating element 30 in position and connects the heating element 30 to the power source. The electric heating elements 30 can be installed in the housing of the electric heating device.

The electronic monitoring system 10 is capable of separately monitoring each of the plurality of electric heating elements 30 to determine that each heating element 30 is functioning to produce heat. Each heating element 30 can be communicatively connected to the computer by a wire so that each heating element 30 is connected to a separate wire and the number of wires corresponds to the number of heating elements 30. The electronic monitoring system 10 is capable of detecting when one or more of the plurality of electric heating elements 30 has ceased functioning.

As explained above, the system 10 can include an alert system. The alert system can be a part of the computer of the electronic monitoring system 10, can be a separate system that is communicatively connected to the computer, or can be a multi-component system of integrated devices and parts that function to alert the user when an electric heating element 30 has ceased to function. The alert system can be programmed to create an alert signal when one or more of the plurality of electric heating elements 30 is detected to have ceased functioning. The computer transmits the alert signal to the alert system and the alert system creates the alert that is detectable by the user to alert the user that one or more of the electric heating elements 30 is not functioning to produce heat.

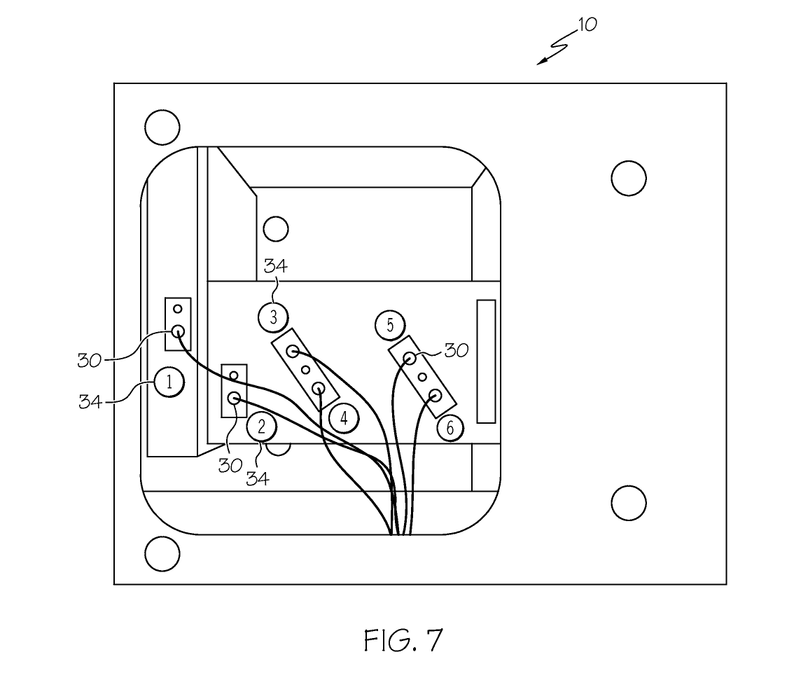

In one embodiment, the alert system can create and transmit a visual alert that is displayed on a display screen 60 connected to the computer, which is perhaps best illustrated in FIG. 1. The display screen 60 may be installed on an exterior surface of the electric heating device so as to be visible from outside the housing of the electric heating device. In another embodiment, the display screen 60 may be installed inside the housing of the electric heating device so as to be visible only when an access panel 22 is removed from a side of the electric heating device. The display screen 60 can be a liquid crystal display, a computer monitor, or any other suitable display screen 60 that is capable of displaying the transmitted visual alert. The visual alert can be a static or flashing light, symbol, alphanumeric character, or image that is created and transmitted from the computer upon detection by the electronic monitoring system 10 of a non-functioning heating element 30. For example, the visual alert could one or more numbers, one or more letters, a combination of one or more numbers and one or more letters, or a symbol, which corresponds to an associated electric heating element 30 being monitored by the system 10 that features a label 34, which can be seen in FIG. 7, having an identical one or more numbers, one or more letters, combination of one or more numbers and one or more letters, or symbol that makes the electric heating element 30 visually identifiable and distinguishable from the other electric heating elements 30.

In another embodiment, the alert system can include individual indicators on the infrared heater, which display a visual indicator as to which of the electric heating elements are functioning or not. The indicators can be LED lights, other light bulbs capable of use as indicators, or liquid crystal displays (LCD) of electric heating element function status. Exemplary embodiments will incorporate LEDs as indicators. For example, in one embodiment, an indicator electrically or communicatively connected to one of the alert system's electric heating elements could remain lit as long as the heating element is operational. In another embodiment, an indicator electrically or communicatively connected to one of the alert system's electric heating elements could become lit only when the heating element becomes non-operational. In these embodiments, the indicators can be installed on a control panel installed on the electric heating device that is part of the system 10. The control panel may include controls and status indicators for other functions and systems of the electric heating device in addition to those described herein, e.g., temperature, timer, or blower speed.

In one example where the system includes six electric heating elements, a control panel of the electric heating device can include six indicators labeled 1 through 6. These labels can correspond to labels 1 through 6 associated with the six electric heating elements of the system. Next to each numbered element label on the control panel, an indicator (e.g., an LED or other light device) can be installed. Each indicator can include lights of different colors (e.g., green and red) so that operational electric heating elements are indicated when the indicator gives off light in one color (e.g., green) while non-operational heating elements are indicated visually by the alert system to be non-operational when the same indicator emits light of a different color (e.g., red). When an electric heating element is not working, and thus non-operational, its corresponding indicator could become lit, flash, or glow with a different color than the color used to indicated when the electric heating element is working and operational. In another embodiment, the indicator may remain lit or glow only when its corresponding electric heating element is operational and may cease emitting light or glowing when the electric heating element becomes non-operational. In another embodiment, the indicator may become lit, flash, or glow only when its corresponding electric heating element becomes non-operational and may be programmed or designed not to emit light, flash, or glow as long as the electric heating element is operational.

In another embodiment, rather than labels, the control panel can include numbers formed from transparent or translucent material that include light sources of any suitable type beneath their surface so that the numbers themselves glow, become lit, or flash when their corresponding electric heating elements become non-operational. In this way, the numbers form the indicators of the alert system. In an alternate embodiment, the numbers may glow or be lit only when their corresponding electric heating elements are operational. In still another embodiment, the numbers may glow or be lit in different colors depending on whether their corresponding electric heating elements are operational or non-operational, e.g., the numbers associated with operational electric heating elements may glow or be lit green while the numbers associated with non-operational electric heating elements may glow, be lit, or flash a different color (e.g., orange, yellow, or red).

In another embodiment, the alert system can create an audio (or sound) alert that is produced or played by an audio device capable of producing a sound. The audio alert can be a tone, a computer-generated voice, a recorded human voice, or any other sound capable of identifying the non-functioning electric heating element 30 to the user. For example, the audio alert could be one tone or a series of tones that correspond to a label 34 that features an identical one or more numbers that makes the electric heating element 30 visually identifiable and distinguishable from the other electric heating elements 30. As a further example, the alert system may play a single tone through the audio device to identify an electric heating element 30 labeled with the number “1” as the non-functioning heating element 30, a series of two consecutive tones to identify an electric heating element 30 labeled with the number “2” as the non-functioning heating element 30, a series of three consecutive tones to identify an electric heating element 30 labeled with the number “3” as the non-functioning heating element 30, and so on similarly for each electric heating element 30 of the electric heating device. In embodiments that utilize a computer-generated voice or a recorded human voice, the alert system may play a pronounced or spoken generated or recorded number or numbers, letter or letters, or combination or one or more numbers and one or more letters, which correspond to an associated electric heating element 30 being monitored by the system 10 that features a label 34 having the same number or numbers, letter or letters, or combination or one or more numbers and one or more letters printed, stamped, embossed, etched, or otherwise marked or affixed thereon so as to render the electric heating element 30 visually identifiable and distinguishable from the other electric heating elements 30.

In some embodiments, the alert system may produce both audio and visual alerts.

The plurality of electric heating elements 30 and other components of the system 10 can be installed within the housing of the electric heating device and are accessible via a removable access panel 22. The removable access panel 22 can form a side wall of the electric heating device. The housing may also include an additional removable inner panel 24 that conceals the plurality of electric heating elements 30 when it is installed over the area in which the sockets 32 are located. When the access panel 22 and inner panel 24 are removed, the user can access and see the plurality of electric heating elements 30 to match the label 34 of the non-functioning heating element 30 with the alert generated by the alert system. Any heating element 30 of the plurality of infrared heating elements, which is indicated by the electronic monitoring system 10 to have ceased functioning, can be removed from the socket 32 in which it is installed and replaced with a replacement heating element 30, e.g., an infrared heating element.

As described above, each of the plurality of heating elements 30 can feature a label 34 that corresponds visually with the visual, audible, or combination of audible and visual alert created by the electronic monitoring system 10.

To monitor the function status of each of the plurality of heating elements 30, the electronic monitoring system 10 can be communicatively connected to the plurality of infrared heating elements by a plurality of wiring components. Each single wiring component of the plurality of wiring components can be communicatively connected to only one of the plurality of infrared heating elements. The label 34 can feature a first label affixed on or near each socket 32 or each heating element 30, and each wiring component of the plurality of wiring components can be identifiable by a second label that is identical to its corresponding first label so that when one of the plurality of infrared heating elements ceases to function, the non-functioning infrared heating element is identifiable by the user based upon the first and second labels associated with the non-functioning infrared heating element and its corresponding unique alert created by the alert system.

The invention also features a method for monitoring the functionality of a heating element 30 installed in a heating device, wherein the heating device is an electric fireplace or an electric heater. In a first step of the method, a plurality of electric heating elements 30 installed in the heating device can be connected to a power source. Next, an electronic monitoring system 10 installed in the heating device can be connected to the power source and communicatively connect the plurality of electric heating elements 30 to the electronic monitoring system 10. The electronic monitoring system 10 can feature a computer and an alert system. The alert system can be used to create an alert to notify a user that at least one of the plurality of electric heating elements 30 has ceased functioning. The alert can be unique to the electric heating element 30 that has ceased to function.

In another step of the method, each of the plurality of electric heating elements 30 can be labeled with a unique label 34 so that when one of the plurality of electric heating elements 30 ceases to function, the non-functioning electric heating element 30 is identifiable by the user based upon the unique label 34 and its corresponding unique alert. In a final step of the method, the electric heating elements 30 that have ceased to function can be replaced based upon the user's identification of that heating element 30 as non-functioning as a result of the user's detection of the alert

### Other Embodiments

While the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for monitoring heating elements, the system comprising:
an electric heating element connected to a power source and installed in a heating device; and
an electronic monitoring system connected to the power source and communicatively connected to the electric heating element, wherein the electronic monitoring system comprises a computer and an alert system for creating an alert to notify a user that the electric heating element has ceased functioning.

2. The system of claim 1, wherein the electric heating element comprises a plurality of heating elements.

3. The system of claim 2, wherein the plurality of heating elements comprises infrared heating elements.

4. The system of claim 2, wherein the plurality of heating elements comprises a combination of infrared heating elements and at least one heating element that is not an infrared heating element.

5. The system of claim 1, wherein the electric heating element is removably installed in a socket.

6. The system of claim 2, wherein the electronic monitoring system separately monitors each of the plurality of infrared heating elements to determine that each heating element is functioning to produce heat.

7. The system of claim 6, wherein the electronic monitoring system is capable of detecting when one or more of the plurality of infrared heating elements has ceased functioning.

8. The system of claim 7, wherein the computer of the electronic monitoring system is programmed to create an alert signal when one or more of the plurality of infrared heating elements is detected to have ceased functioning.

9. The system of claim 8, wherein the computer transmits the alert signal to the alert system and wherein the alert system creates the alert that is detectable by the user to alert the user that one or more of the plurality of infrared heating elements is not functioning to produce heat.

10. The system of claim 9, wherein the system further comprises a display screen and the alert comprises a visual alert that is displayed on the display screen.

11. The system of claim 9, wherein the system further comprises an audio device capable of producing a sound and the alert comprises a sound that is produced by the audio device.

12. The system of claim 9, wherein the system is capable of producing a plurality of alerts each of which is unique to one of the plurality of infrared heating elements that ceases to function.

13. The system of claim 1, wherein the heating device comprises an electric heater.

14. The system of claim 13, wherein the system is installed within a housing of the electric heater and is accessible via a removable panel.

15. The system of claim 1, wherein the heating device comprises an electric fireplace.

16. The system of claim 15, wherein the system is installed within a housing of the electric fireplace and is accessible via a removable panel.

17. The system of claim 2, wherein each of the plurality of infrared heating elements comprises a label that corresponds visually with the alert created by the electronic monitoring system.

18. The system of claim 17, wherein the electronic monitoring system is communicatively connected to the plurality of infrared heating elements by a plurality of wiring components, wherein each single wiring component of the plurality of wiring components is communicatively connected to only one of the plurality of infrared heating elements, wherein the label comprises a first label, and wherein each wiring component of the plurality of wiring components is identifiable by a second label that is identical to its corresponding first label so that when one of the plurality of infrared heating elements ceases to function, the non-functioning infrared heating element is identifiable by the user based upon the first and second labels associated with the non-functioning infrared heating element and its corresponding unique alert created by the alert system.

19. The system of claim 17, wherein any heating element of the plurality of infrared heating elements, which is indicated by the electronic monitoring system to have ceased functioning, is removable from a socket in which it is installed and is replaceable with a replacement infrared heating element.

20. A method for monitoring the functionality of a heating element installed in a heating device comprising an electric fireplace or an electric heater, the method comprising the steps of:
(a) connecting a plurality of electric heating elements installed in the heating device to a power source;
(b) connecting an electronic monitoring system installed in the heating device to the power source and communicatively connecting the plurality of electric heating elements to the electronic monitoring system, wherein the electronic monitoring system comprises a computer and an alert system; and
(c) using the alert system, creating an alert to notify a user that at least one of the plurality of electric heating elements has ceased functioning.

21. The method of claim 20, wherein the alert is unique to the at least one of the plurality of electric heating elements that has ceased to function.

22. The method of claim 21, wherein the method further comprises the step of:
(d) labeling each of the plurality of electric heating elements with a unique label so that when at least one of the plurality of electric heating elements ceases to function, the at least one non-functioning electric heating element is identifiable by the user based upon the unique label and its corresponding unique alert.

23. The method of claim 22, wherein the electronic monitoring system is communicatively connected to the plurality of infrared heating elements by a plurality of wiring components, wherein each single wiring component of the plurality of wiring components is communicatively connected to only one of the plurality of infrared heating elements, wherein the unique label comprises a first label, and wherein the method further comprises the step of:
(e) labeling each wiring component of the plurality of wiring components with a second label that is identical to its corresponding first label, and when one of the plurality of infrared heating elements ceases to function, identifying the non-functioning infrared heating element based upon the first and second labels associated with the non-functioning infrared heating element and its corresponding unique alert created by the alert system.

24. The method of claim 20, wherein the method further comprises the step of:
(f) replacing the at least one of the plurality of electric heating elements that has ceased to function based upon the user's identification of that heating element as non-functioning as a result of the user's detection of the alert.
